(19) United States
(12) Patent Application Publication
(10) Pub. No.: US 2013/0246525 A1
(43) Pub. Date: Sep. 19, 2013

(54) INSTANT TRANSITION FROM A PUBLIC CONVERSATION THREAD TO A PRIVATE CHAT OR INSTANT MESSAGE ENVIRONMENT

(71) Applicants: Dipak Patil, Miraj (IN); Joseph M. Olsen, Mountain House, CA (US); Zachary Dunn, San Francisco, CA (US)

(72) Inventors: Dipak Patil, Miraj (IN); Joseph M. Olsen, Mountain House, CA (US); Zachary Dunn, San Francisco, CA (US)

(73) Assignee: SALESFORCE.COM, INC., San Francisco, CA (US)

(21) Appl. No.: 13/423,120

(22) Filed: Mar. 16, 2012

(51) Int. Cl. G06F 15/16

(52) U.S. Cl. 709/204

(57) ABSTRACT

A system and related operating methods for transitioning an electronically displayed public mode of written conversation to an electronically displayed private mode of written conversation are presented here. The system operates by identifying a displayed public thread that conveys a conversation among a plurality of users, and by receiving an instruction to transition at least some content of the displayed public thread to a private setting. In response to receiving the instruction, the system initiates a private communication application, and then continues the conversation among at least some of the plurality of users in a private environment, using the private communication application.

### TECHNICAL FIELD

Embodiments of the subject matter described herein relate generally to various modes of written communication carried out between users of computer systems. More particularly, the subject matter relates to a technique for quick and easy transition from a public forum (such as public conversation thread displayed in connection with a social network space) to a private forum (such as a live chat or private message environment).

### BACKGROUND

The Internet has led to a massive increase in publicly available written communication modes, such as discussion forums that maintain many conversation threads, social network sites that allow users to maintain wall postings and conversation threads, blogs that allow public comments, and the like. There are certain times when a public discussion (e.g., a public conversation thread) should be taken “offline” and into a private or less conspicuous environment, such as a live chat room, a private message conversation, or the like. Existing websites and applications, however, make it difficult and time consuming to transition from a public forum to a private forum. For example, a user must launch a private communication application (e.g., a chat window), manually invite participants, and summarize or copy and paste the content of the previous discussion into the chat window. This routine can be time consuming, frustrating, and prone to human error.

Accordingly, it is desirable to have an efficient and effective methodology for allowing users to move a public conversation thread into a private format. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary embodiment of a computer-implemented system;

FIG. 2 is a schematic representation of an exemplary embodiment of an apparatus suitable for use in a system such as that depicted in FIG. 1;

FIG. 3 is a diagram that depicts public conversation threads that are visible to a group of users;

FIG. 4 is a flow chart that illustrates an exemplary embodiment of an instant public-to-private transition process;

FIG. 5 is a diagram that depicts a private conversation thread associated with a private communication application; and

FIG. 6 is a schematic representation of an exemplary embodiment of a multi-tenant application system.

### DETAILED DESCRIPTION

The exemplary embodiments presented here relate to a computer-implemented system and related processes that accommodate a variety of different written communication modes, such as email, social network postings, public conversation threads, live chat, instant messaging (IM), private messaging (PM), text messaging, etc. Certain exemplary embodiments are described here in the context of an online or web-based social networking or collaboration site where members or subscribers can post messages, comments to posted messages, and the like. As described in more detail below, the exemplary methodology described here enables a public conversation (such as a forum thread) to be quickly and easily converted into a private conversation with some or all of the existing participants. In certain implementations, this functionality can be achieved through the use of “instant groups” of users, where the list of participants in the public conversation is identified for purposes of creating the group of participants or members to be invited to the private conversation.

A system and method for providing instant groups of users on a social network can be utilized to quickly and easily transition from a public (or non-private) conversation, which can be viewed by a relatively large group of users, to a private conversation that can only be viewed by a relatively small group of users. In this regard, users of social networks may want to use the social network to collaborate briefly during meetings and/or on projects that have definite lifespans. Currently, when a user creates a group to collaborate, the group exists and occupies memory space for an indeterminate amount of time, or until it is actively deleted.

An embodiment of this disclosure contemplates creation of a group having a defined temporal life span, i.e., an “instagroup.” In practice, this instagroup can be used to support a private mode of conversation, such as IM, PM, live chat, or the like. Alternatively or additionally, a defined group of users having a limited and defined lifespan can be created such that a social network application (or any suitable application) can support certain group functionality during the limited lifespan of the group. Once the lifespan of the group ends, the group is either automatically deleted or auto-archived. In other words, the group ceases to function and may not show up in search results or in a user's feed.

In a non-limiting use case, a social network user may participate in a teleconference with one or more other social network users. The user decides he would like to post ideas and other information, including documents, that are being discussed during the teleconference. At this time, the user can create an instagroup and provide group configuration data that indicates a limited and defined lifespan to be applied to the instagroup. For example, during the creation process, the user may be asked to provide a temporal lifespan for the group. Thus, the user might define the lifespan to be two hours (e.g., the duration of the teleconference). As another example, the lifespan of an instagroup could be defined in accordance with criteria related to the operating status of the host system. In this regard, an instagroup could be defined to exist for as long as one or more applications or programs remain open or in active use by at least one user of the group. As an alternative, an instagroup could be defined to exist for as long as at least one (or any defined number) of users remains online with the host system, which may be a social network application. Once created, the user adds the other users from the teleconference to the group (or asks them to “follow” it).

The user may then post documents, comments, and other information in a private setting for feedback, remarks, instructions, etc. Once the lifespan is up, in an embodiment, the user may be prompted to extend the lifespan of the instagroup. Alternatively, the group is automatically deleted and/or archived.

In an embodiment, a social network user can create an instagroup for purposes of facilitating an online chat session. Present social networks can have a conversation thread that identifies, tags, or “@mentions” other social network users. Rather than continuing a public thread as a series of ongoing posts, it may be useful to collaborate with specific users in real-time, i.e., create a temporary online chat session or otherwise private conversation environment. Currently, users must be added one by one, and the context of the online chat session may be lost.

Creation of an online chat instagroup solves these issues, since the purpose of the instagroup and its lifespan can be configured at creation. As such, each member of the instagroup could be immediately given the purpose and duration of the proposed online chat. In an embodiment, an instagroup can be created or initiated using an icon, text, or button that will trigger creation of an instagroup. Other embodiments may be possible without departing from the scope of this disclosure.

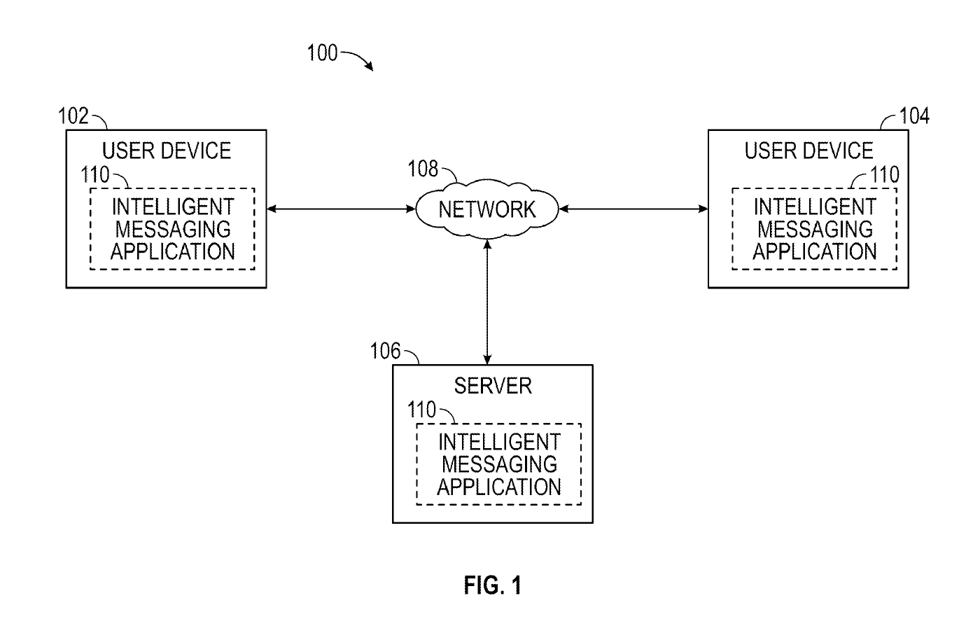

Referring now to the drawings, FIG. 1 is a schematic representation of an exemplary embodiment of a computer-implemented system 100, which is suitably configured to support at least one non-private or public mode of user communication and at least one private mode of user communication. In this regard, the system 100 may support a variety of messaging, communication, discussion, commenting, and/or posting applications. In various embodiments, the system 100 may support any or all of the following applications, without limitation: a live chat application; an IM application; a PM application; a text messaging application; a commenting application that allows registered or anonymous users to post remarks (such as the type found on some websites); a discussion forum application (e.g., a web-based bulletin board application); an email system; a private or secure feature of a social network application; a private or secure feature of an enterprise collaboration application; or the like.

The illustrated embodiment of the system 100 includes a first user device 102, a second user device 104, and a server system 106 operatively coupled to each other through a data communication network 108. The system 100 is preferably realized as a computer-implemented system in that the user devices 102, 104 and the server system 106 are configured as computer-based electronic devices.

Although only two user devices 102, 104 are shown in FIG. 1, an embodiment of the system 100 could support any number of user devices. Indeed, one benefit of the embodiments described here is the ability to support conversations (public and private) among a plurality of different users, with little to no limitation on the number of users that can participate in any given conversation thread. Each user device supported by the system 100 may be implemented using any suitable hardware platform. In this regard, a user device may be realized in any common form factor including, without limitation: a desktop computer; a mobile computer (e.g., a tablet computer, a laptop computer, or a netbook computer); a smartphone; a video game device; a digital media player; a piece of home entertainment equipment; or the like. Each user device supported by the system 100 is realized as a computer-implemented or computer-based device having the hardware, software, firmware, and/or processing logic needed to carry out the intelligent messaging techniques and methodologies described in more detail herein.

The server system 106 can be deployed in certain embodiments of the system 100 to manage, handle, and/or serve some or all of the message/conversation related functionality for the user devices 102, 104. In practice, the server system 106 may be realized as a computer-implemented or computer-based system having the hardware, software, firmware, and/or processing logic needed to carry out the various processes, techniques, and methodologies described in more detail herein. It should be appreciated that the server system 106 need not be deployed in embodiments where the user devices 102, 104 perform the desired functionality. In other words, the methodology described herein could be implemented at the local client device level without relying on any centralized processing at the server level. Moreover, in certain embodiments the desired functionality could be executed or performed in a distributed manner across the server system 106 and one or more of the user devices 102, 104.

The system 100 may include an intelligent “messaging” application 110, which may be realized at the user device 102 only, at the user device 104 only, at the server system 106 only, or distributed across any of the user devices 102, 104 and the server system 106. The intelligent messaging application 110 may include or be associated with one or more non-private communication applications and one or more private communication applications that maintain and support conversations among a plurality of users. The communication applications may be considered to be a part of the intelligent messaging application 110, or they may be standalone applications that are managed, controlled, or otherwise handled by the intelligent messaging application 110. Indeed, a given communication application may be resident at one or both of the user devices 102, 104 and designed to be launched and supported by the intelligent messaging application 110 resident at the server system 106. The intelligent messaging application 110 may also be responsible for the transition from a non-private or public communication mode to a private communication mode. To this end, the user devices 102, 104 may include or cooperate with the intelligent messaging application 110 as needed.

The data communication network 108 provides and supports data connectivity between the user devices 102, 104 and the server system 106. In practice, the data communication network 108 may be any digital or other communications network capable of transmitting messages or data between devices, systems, or components. In certain embodiments, the data communication network 108 includes a packet switched network that facilitates packet-based data communication, addressing, and data routing. The packet switched network could be, for example, a wide area network, the Internet, or the like. In various embodiments, the data communication network 108 includes any number of public or private data connections, links or network connections supporting any number of communications protocols. The data communication network 108 may include the Internet, for example, or any other network based upon TCP/IP or other conventional protocols. In various embodiments, the data communication network 108 could also incorporate a wireless and/or wired telephone network, such as a cellular communications network for communicating with mobile phones, personal digital assistants, and/or the like. The data communication network 108 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

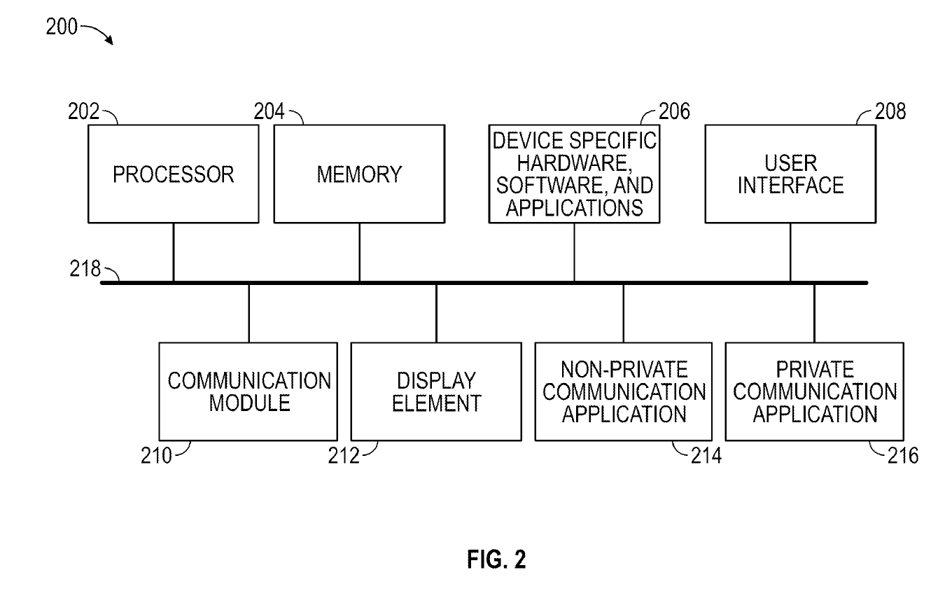

FIG. 2 is a schematic representation of an exemplary embodiment of an apparatus, system, or device 200 suitable for use in a system such as that depicted in FIG. 1. In practice, the user devices 102, 104 and the server system 106 could be generally configured and implemented as shown in FIG. 2. Thus, the following general description of the device 200 may be applicable to the user device 102, the user device 104, and/or the server system 106.

The illustrated embodiment of the device 200 includes, without limitation: at least one processor 202; a suitable amount of memory 204; device-specific hardware, software, firmware, and/or applications 206; a user interface 208; a communication module 210; a display element 212; at least one non-private communication application 214; and at least one private communication application engine 216. Of course, the device 200 may include additional elements, components, modules, and functionality configured to support various features that are unrelated to the subject matter described here. For example, the device 200 may include certain features and elements to support conventional functions that might be related to the particular implementation and deployment of the device 200. In practice, the elements of the device 200 may be coupled together via a bus or any suitable interconnection architecture 218.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor 202 such that the processor 202 can read information from, and write information to, the memory 204. In the alternative, the memory 204 may be integral to the processor 202. As an example, the processor 202 and the memory 204 may reside in an ASIC. The memory 204 can be used to store computer-readable media, where a tangible computer-readable medium has computer-executable instructions stored thereon (accordingly, the computer-readable medium is typically non-transitory in nature). The computer-executable instructions, when read and executed by the device 200, cause the device 200 to perform certain tasks, operations, functions, and processes described in more detail herein. In this regard, the memory 204 may represent one suitable implementation of such computer-readable media. Alternatively or additionally, the device 200 could receive and cooperate with computer-readable media (not separately shown) that is realized as a portable or mobile component or platform, e.g., a portable hard drive, a USB flash drive, an optical disc, or the like.

The device-specific hardware, software, firmware, and applications 206 may vary from one embodiment of the device 200 to another. For example, the device-specific hardware, software, firmware, and applications 206 will support telephone functions and features when the device 200 is realized as a mobile telephone, conventional personal computer functions and features if the device 200 is realized as a desktop or portable computer, and server functions and features if the device 200 is realized as a server system (including, in certain embodiments, web server functionality). In practice, certain portions or aspects of the device-specific hardware, software, firmware, and applications 206 may be implemented in one or more of the other blocks depicted in FIG. 2.

The user interface 208 may include or cooperate with various features to allow a user to interact with the device 200. Accordingly, the user interface 208 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the device 200. In various embodiments, the user interface 208 may include one or more graphical user interface (GUI) control elements that enable a user to manipulate or otherwise interact with an application via the display element 212.

The communication module 210 facilitates data communication between the device 200 and other components as needed during the operation of the device 200. In the context of this description, the communication module 210 can be employed during a messaging session that includes the device 200 as one of the participant devices. An embodiment of the device 200 may support wireless data communication and/or wired data communication, using various data communication protocols. For example, the communication module could support one or more wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Moreover, the communication module could support one or more wired/cabled data communication protocols, including, without limitation: Ethernet; home network communication protocols; USB; IEEE 1394 (Firewire); hospital network communication protocols; and proprietary data communication protocols.

The display element 212 is suitably configured to enable the device 200 to render and display various screens, GUIs, GUI control elements, drop down menus, auto-fill fields, text entry fields, message fields, or the like. Of course, the display element 212 may also be utilized for the display of other information during the operation of the device 200, as is well understood. Notably, the specific configuration, operating characteristics, size, resolution, and functionality of the display element 212 can vary depending upon the practical implementation of the device 200. For example, if the device 200 is a desktop computer, then the display element 212 may be a relatively large monitor. Alternatively, if the device 200 is a cellular telephone device, then the display element 212 may be a relatively small integrated display screen, which may be realized as a touch screen.

The non-private communication application 214 may refer to hardware, software, firmware, and/or processing logic that supports one or more non-private communication technologies utilized by the system described herein. The term “non-private” or “public” may be used herein to refer to a communication application (e.g., the non-private communication application 214) that can be viewed by the public, by a relatively large and unregulated group of users, by users having access to the application via an open or public resource such as the Internet, or the like. In certain embodiments, public users can access and view conversations maintained by the non-private communication application 214 without having to enter any credentials, and without having to satisfy any login requirements, security requirements, or the like.

Although not always required, in certain embodiments a server system maintains and provides the non-private communication application 214 as an online network-based application. As one non-limiting example, a public and open “wall” in a social networking application may represent one type of non-private communication application 214. As another non-limiting example, a publicly viewable Internet discussion forum or chat room may be considered to be another type of non-private communication application 214. As yet another example, a non-private communication application 214 may be implemented in connection with a news-related website, an online shopping website, or any website that provides readers with the opportunity to post online comments, remarks, reviews, or ratings.

The private communication application 216 may refer to hardware, software, firmware, and/or processing logic that supports one or more private communication technologies utilized by the system described herein. The term “private” may be used herein to refer to a communication application (e.g., the private communication application 216) that is not designed to be readily viewed by the public or by an unspecified group of users. Rather, access to the private communication application 216 is controlled or otherwise regulated by way of designated user groups, invitations, user credentials, or the like. In other words, conversations maintained and supported by the private communication application 216 may be designed to have a limited or defined audience that can be designated by one or more authorized participants. It should be appreciated that any of the public application types mentioned above could also serve as a private communication application 216 (e.g., by utilizing or requiring user credentials, or by restricting viewing and/or participation access to only a defined group of users). Moreover, the private communication application 216 may be maintained and provided by a server system as a suitable online network-based application.

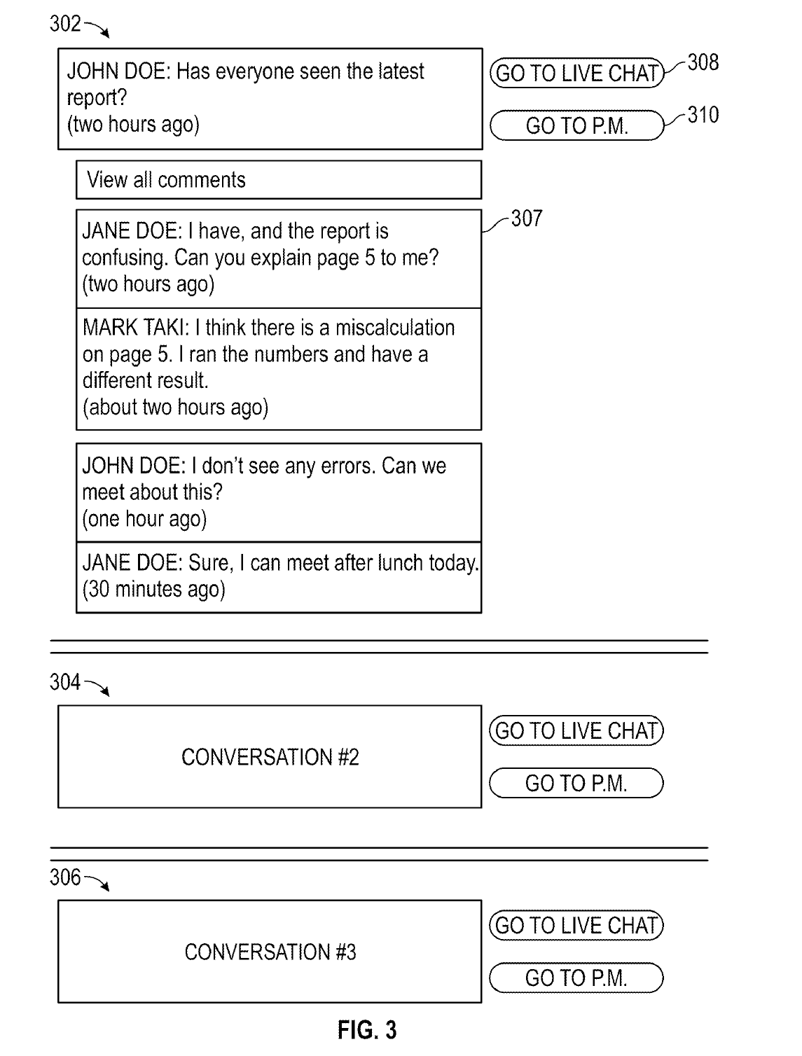

FIG. 3 is a diagram that depicts public conversation threads 302, 304, 306 that are visible to a group of users. These threads 302, 304, 306 may be generated and provided by a suitably configured non-private communication application. In certain embodiments, the threads 302, 304, 306 may be displayed on a display element of a user device, e.g., within a web browser window. The public conversation threads 302, 304, 306 may be associated with an account in a social networking application, a public online discussion forum, a public online commenting feature or page, a public chat room, or the like. For simplicity, only one thread (namely, the public conversation thread 302) is depicted in detail. For this example, the user John Doe created the public conversation thread 302 with his original post 307, which appears at the top of the public conversation thread 302. Due to the public nature of the thread 302, anyone having access to the hosting site or application will be able to at least view the original post 307. Moreover, it may be possible for some people to post comments or replies to the original post 307. This example shows four additional posts in the thread 302: two made by Jane Doe, one made by Mark Taki, and one made by John Doe (the owner of the thread).

For this particular embodiment, the non-private application that hosts the public thread functionality also provides at least one GUI control element that allows a user (e.g., the owner of the thread, John Doe) to move public conversation threads to a private setting or environment such as live chat, PM, IM, or other collaborative communication tool. In this regard, FIG. 3 depicts two exemplary GUI control elements, namely, a “Go To Live Chat” button 308 and a “Go To P.M.” button 310. Although not always required, these GUI control elements could be provided next to each public conversation thread 302, 304, 306, as shown in FIG. 3. Alternatively, one set of GUI control elements could be provided for general applicability to any public thread that is selected or otherwise identified for transitioning into the private environment.

If the “Go To Live Chat” button 308 is activated or selected by a user, the system automatically moves a transcription of at least a portion of the public conversation thread 302 into a live chat application, where the conversation can be continued using a private conversation application in lieu of the public conversation thread 302. If the “Go To P.M.” button 310 is activated or selected by the user, the system automatically moves a transcription of at least some of the content of the public conversation thread 302 into a private PM application for continuation of the conversation in a private manner.

Although only two options are depicted in FIG. 3 (namely, live chat and PM), it should be appreciated that the system described here could provide any number of additional options to allow the user to instantly convert the public conversation thread into a private format. Accordingly, additional GUI control elements could be rendered to enable the user to elect other private communication applications if so desired, such as email, text messaging, a private discussion forum, a secure password protected “wall” of a social networking site, or the like.

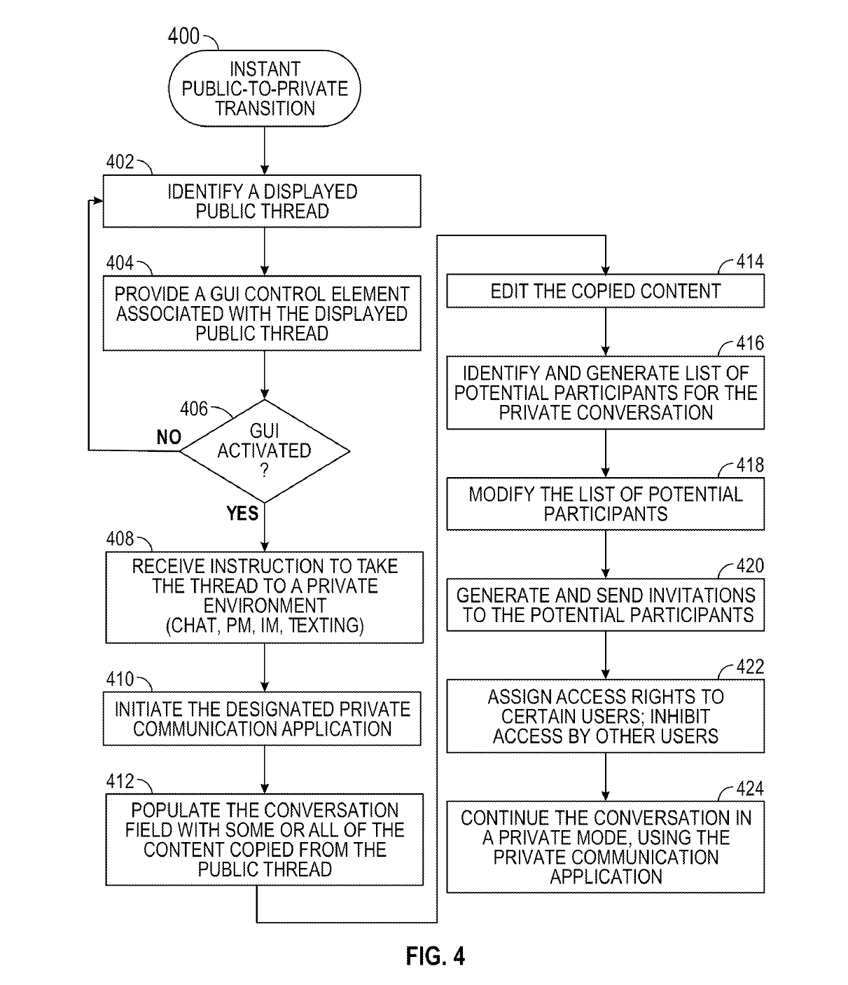

FIG. 4 is a flow chart that illustrates an exemplary embodiment of an instant public-to-private transition process 400. The various tasks performed in connection with the process 400 may be performed by software, hardware, firmware, or any combination thereof. For illustrative purposes, the following description of the process 400 may refer to elements mentioned above in connection with FIGS. 1-3. In practice, portions of the process 400 may be performed by different elements of the described system, e.g., a user device, a display element, a server system, a native application running at a user device, or a functional module or component of a user device or the server system. It should be appreciated that the process 400 may include any number of additional or alternative tasks, the tasks shown in FIG. 4 need not be performed in the illustrated order, and the process 400 may be incorporated into a more comprehensive procedure or process having additional functionality not described in detail herein. Moreover, one or more of the tasks shown in FIG. 4 could be omitted from an embodiment of the process 400 as long as the intended overall functionality remains intact.

The process 400 assumes that a public communication application is already displaying, providing, and maintaining at least one public conversation thread in a mode that allows the thread(s) to be viewed by a first group of users, such as anyone having Internet access to the website that is hosting the thread(s). Each public thread is maintained and supported by a non-private communication application, as described above. In practice, a conversation thread will typically convey a conversation or discourse (i.e., conversation content) among a plurality of users. The illustrated embodiment of the process 400 identifies a public thread of interest that conveys a publicly viewable conversation among a plurality of users (task 402). For this example, task 402 identifies the public conversation thread 302 depicted in FIG. 3.

The process 400 may generate and provide at least one GUI control element for the displayed and/or identified public threads (task 404). As explained above with reference to FIG. 3, each publicly displayed conversation thread may have a corresponding set of GUI control elements associated therewith. In certain embodiments, the identification of a particular public conversation thread (corresponding to task 402) may be associated with the activation of a GUI control element for that particular thread. This description assumes that the process 400 detects activation or selection of a GUI control element for the identified public conversation thread (the “Yes” branch of query task 406). In practice, a user of the non-private communication application (typically the account owner, the owner of the thread, the original poster, or the like) activates the GUI control element when he or she decides to move the public conversation into a private or secure setting.

In response to the activation of the GUI control element, the process 400 receives a suitably formatted instruction or a command to transition at least some of the content of the displayed public thread from the public arena to a private setting or to a private communication environment (task 408). The received instruction causes the process 400 to initiate or launch one or more designated private communication applications (task 410) for presentation at the user device. For example, task 410 may be associated with the opening of a live chat window, the activation of a PM feature, the display of an appropriate webpage, or the like. The exemplary embodiment presented here automatically copies at least a portion of the content of the displayed public thread and populates a conversation field or text window of the private communication application with the copied content (task 412). The copied content is desirable to maintain the continuity and relevance of the conversation, and to ensure that all relevant discussions are captured in the private environment. In certain embodiments, task 412 automatically copies all of the content from the public thread, and the process 400 enables the user to edit the copied content if so desired (task 414) before the private communication session begins. This enables the owner of the conversation to remove irrelevant or unnecessary comments, focus the conversation, and/or otherwise improve the content before launching the private session.

The process 400 may also identify and generate a list of potential participants for continuing the conversation with the private communication application (task 416). In practice, the list prepared during task 416 will include at least some of the users participating in the public conversation thread. In certain embodiments, the list prepared during task 416 will by default include all of the participants of the public thread, and only those participants. That said, the initial list of potential participants can be modified if so desired (task 418) by adding new users, removing one or more existing users, or the like. This feature may be desirable to ensure that the appropriate people are invited to continue in the private discussion. Accordingly, the group of users intended to participate in the private communication session might only include members selected from the original plurality of users (i.e., those participating in the non-private discussion). Alternatively, the group of users intended to participate in the private communication session might include at least some of the original users, with or without additional/new users. In any case, the process 400 ultimately identifies the members of the private group of users, which may be selected by the owner of the account, the thread starter, or the like.

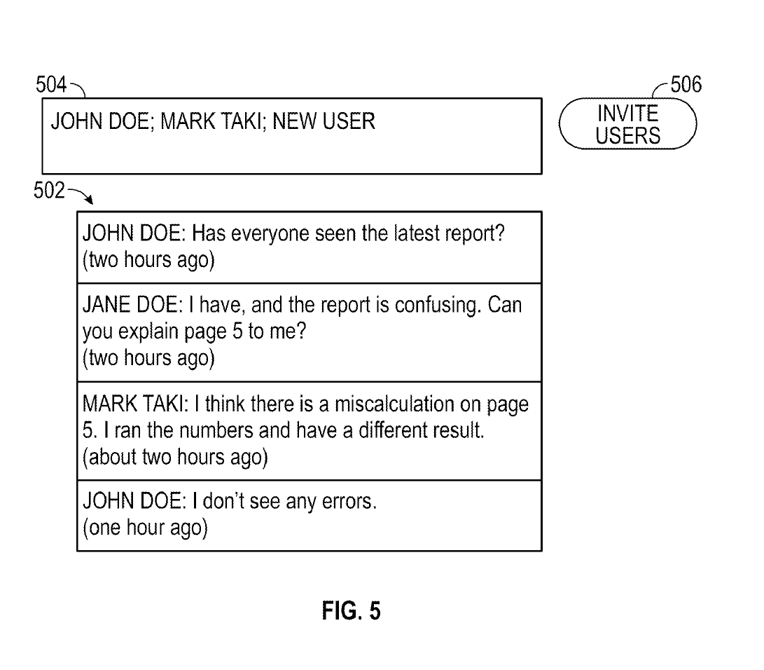

Referring now to FIG. 5, a private conversation thread 502 is depicted. The private conversation thread 502 may be maintained and provided by any private communication application. FIG. 5 follows the example described above with reference to FIG. 3. In other words, the private conversation thread 502 corresponds to the public conversation thread 302 after it has been transitioned to a private mode of communication. Notably, most of the content of the public conversation thread 302 has been copied and preserved in the private conversation thread 502. Some of the original content, however, has been edited. For example, the private conversation thread 502 no longer includes the last entry made by Jane Doe in the public conversation thread 302. In addition, the final entry made by John Doe in the public conversation thread 302 has been shortened.

FIG. 5 also shows a participants field 504 that is displayed with the private conversation thread 502. In accordance with the embodiment of the process 400 described here, the participants field 504 may be automatically populated with some or all of the participants of the original non-private thread (for this particular example, the name John Doe does not appear in the participants field 504 because he is the originator of the private session and, therefore, need not be included in the participants field 504). Accordingly, the participants field 504 in FIG. 5 includes both Jane Doe and Mark Taki, both of whom are participants in the public conversation thread 302 shown in FIG. 3. FIG. 5 depicts a scenario where the list of potential participants has been modified by the user. In this regard, the participants field 504 also includes New User to indicate that the user intends to extend the private discussion to someone who did not participate in the public conversation thread 302.

FIG. 5 also depicts a GUI control element that takes the form of an “Invite Users” button 506. The “Invite Users” button 506 is displayed in connection with the participants field 504, and activation of the “Invite Users” button 506 causes the system to generate and send invitations or notifications to the users that appear in the participants field 504. The invitations inform the users that a private conversation has been initiated. This allows the users to confirm participation, access the private conversation thread 502, enter their credentials to obtain viewing access, or the like.

Referring back to FIG. 4, the process 400 may generate and send invitations to the potential participants (task 420), asking them to join the private conversation. As mentioned above, suitable invitations may be generated and sent in response to user activation of the “Invite Users” button 506. In practice, activation of the “Invite Users” button 506 may also cause the system to assign certain access rights (for the private conversation thread 502) to the identified users, and/or to inhibit access to the private conversation thread 502 by other users, i.e., any user not identified in the participants field 504 (task 422). An invitation could be sent as an email, an HTML document, a text message, a PM, a pop-up message, a voice mail, a posting in the public thread, or the like. This allows the original conversation to be continued in a discreet manner without public knowledge. Moreover, an invitation might include a link or a URL that points to a registration or sign-in page to confirm each user's actual participation in the private conversation thread.

This example assumes that all of the invited participants respond by participating in the private conversation. Accordingly, the process 400 may continue the conversation among the defined group of users in a private environment, using the designated private communication application (task 424). In this regard, the private communication application can be used to provide and maintain a new conversation thread that contains at least some of the conversation content from the previous (non-private) conversation thread.

In certain embodiments, the originally displayed public thread may be associated with an account in a social networking application, where that account belongs to one of the participants/users of the public communication application. In accordance with one exemplary implementation, when the user issues an instruction to transition the public conversation to a private conversation, the system creates an appropriate database object that corresponds to a new group of users. As mentioned above, the new group of users can be created automatically and such that the associated database object only exists for a limited and defined period of time (which may be selectable by the user). Consequently, the private conversation environment may only be valid and active for a limited amount of time and, upon completion of the defined time duration, the system may automatically delete or archive the database object corresponding to the group that had been used to facilitate the private conversation.

The exemplary embodiments presented here relate to various computer-implemented and computer-executed techniques related to messaging systems and the transition of conversations from a public forum to a private forum. The described subject matter could be implemented in connection with any suitable computer-based architecture, system, network, or environment, such as two or more user devices that communicate via a data communication network. Although the subject matter presented here could be utilized in connection with any type of computing environment, certain exemplary embodiments can be implemented in conjunction with a multi-tenant database environment.

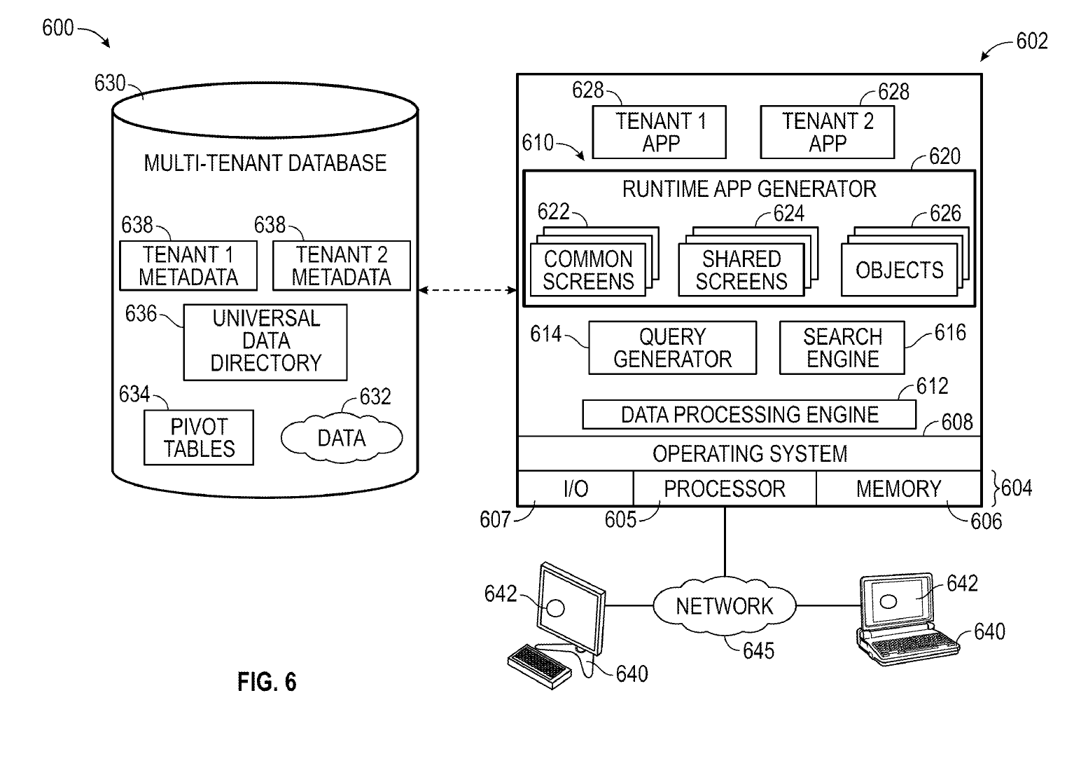

In this regard, an exemplary embodiment of a multi-tenant application system 600 is shown in FIG. 6. The system 600 suitably includes a server 602 that dynamically creates virtual applications 628 based upon data 632 from a common database 630 that is shared between multiple tenants. Data and services generated by the virtual applications 628 are provided via a network 645 to any number of user devices 640, as desired. Each virtual application 628 is suitably generated at run-time using a common application platform 610 that securely provides access to the data 632 in the database 630 for each of the various tenants subscribing to the system 600. In accordance with one non-limiting example, the system 600 may be implemented in the form of a multi-tenant CRM system that can support any number of authenticated users of multiple tenants.

A “tenant” or an “organization” generally refers to a group of users that shares access to common data within the database 630. Tenants may represent customers, customer departments, business or legal organizations, and/or any other entities that maintain data for particular sets of users within the system 600. Although multiple tenants may share access to the server 602 and the database 630, the particular data and services provided from the server 602 to each tenant can be securely isolated from those provided to other tenants. The multi-tenant architecture therefore allows different sets of users to share functionality without necessarily sharing any of the data 632.

The database 630 is any sort of repository or other data storage system capable of storing and managing the data 632 associated with any number of tenants. The database 630 may be implemented using any type of conventional database server hardware. In various embodiments, the database 630 shares processing hardware 604 with the server 602. In other embodiments, the database 630 is implemented using separate physical and/or virtual database server hardware that communicates with the server 602 to perform the various functions described herein.

The data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants. Tenant-specific formatting, functions and other constructs may be maintained as tenant-specific metadata 638 for each tenant, as desired. Rather than forcing the data 632 into an inflexible global structure that is common to all tenants and applications, the database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data 632 from the database 630.

The server 602 is implemented using one or more actual and/or virtual computing systems that collectively provide the dynamic application platform 610 for generating the virtual applications 628. The server 602 operates with any sort of conventional processing hardware 604, such as a processor 605, memory 606, input/output features 607 and the like. The processor 605 may be implemented using one or more of microprocessors, microcontrollers, processing cores and/or other computing resources spread across any number of distributed or integrated systems, including any number of “cloud-based” or other virtual systems. The memory 606 represents any non-transitory short or long term storage capable of storing programming instructions for execution on the processor 605, including any sort of random access memory (RAM), read only memory (ROM), flash memory, magnetic or optical mass storage, and/or the like. The server 602 typically includes or cooperates with some type of computer-readable media, where a tangible computer-readable medium has computer-executable instructions stored thereon. The computer-executable instructions, when read and executed by the server 602, cause the server 602 to perform certain tasks, operations, functions, and processes described in more detail herein. In this regard, the memory 606 may represent one suitable implementation of such computer-readable media. Notably, the processor 605 and the memory 606 may be suitably configured to carry out the various messaging and network-based features described above.

The input/output features 607 represent conventional interfaces to networks (e.g., to the network 645, or any other local area, wide area or other network), mass storage, display devices, data entry devices and/or the like. In a typical embodiment, the application platform 610 gains access to processing resources, communications interfaces and other features of the processing hardware 604 using any sort of conventional or proprietary operating system 608. As noted above, the server 602 may be implemented using a cluster of actual and/or virtual servers operating in conjunction with each other, typically in association with conventional network communications, cluster management, load balancing and other features as appropriate.

The application platform 610 is any sort of software application or other data processing engine that generates the virtual applications 628 that provide data and/or services to the user devices 640. The virtual applications 628 are typically generated at run-time in response to queries received from the user devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the user devices 640. The virtual applications 628 created by tenants are typically constructed in accordance with the tenant-specific metadata 638, which describes the particular tables, reports, interfaces and/or other features of the particular application. In various embodiments, each virtual application 628 generates dynamic web content (including GUIs, detail views, secondary or sidebar views, and the like) that can be served to a browser or other client program 642 associated with its user device 640, as appropriate.

The runtime application generator 620 suitably interacts with the query generator 614 to efficiently obtain multi-tenant data 632 from the database 630 as needed. In a typical embodiment, the query generator 614 considers the identity of the user requesting a particular function, and then builds and executes queries to the database 630 using system-wide metadata 636, tenant specific metadata 638, pivot tables 634, and/or any other available resources. The query generator 614 in this example therefore maintains security of the common database 630 by ensuring that queries are consistent with access privileges granted to the user that initiated the request.

The data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc. In certain embodiments, the data processing engine 612 and the processor 605 cooperate in an appropriate manner to perform and manage various techniques, processes, and methods associated with intelligent messaging, as described previously with reference to FIGS. 1-5.

In operation, developers use the application platform 610 to create data-driven virtual applications 628 for the tenants that they support. Such virtual applications 628 may make use of interface features such as tenant-specific screens 624, universal screens 622 or the like. Any number of tenant-specific and/or universal objects 626 may also be available for integration into tenant-developed virtual applications 628. The data 632 associated with each virtual application 628 is provided to the database 630, as appropriate, and stored until it is requested or is otherwise needed, along with the metadata 638 that describes the particular features (e.g., reports, tables, functions, etc.) of that particular tenant-specific virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the database 630. In this regard, the object type defines the structure (e.g., the formatting, functions and other constructs) of each respective object 626 and the various fields associated therewith. In an exemplary embodiment, each object type includes one or more fields for indicating the relationship of a respective object of that object type to one or more objects of a different object type (e.g., master-detail, lookup relationships, or the like).

In exemplary embodiments, the application platform 610, the data processing engine 612, the query generator 614, and the processor 605 cooperate in an appropriate manner to process data associated with a hosted virtual application 628 (such as a CRM application), generate and provide suitable GUIs (such as web pages) for presenting data on client devices 640, and perform additional techniques, processes, and methods to support the features and functions related to the provision of messaging features and functions for the hosted virtual application 628.

Still referring to FIG. 6, the data and services provided by the server 602 can be retrieved using any sort of personal computer, mobile telephone, portable device, tablet computer, or other network-enabled user device 640 that communicates via the network 645. Typically, the user operates a conventional browser or other client program 642 to contact the server 602 via the network 645 using, for example, the hypertext transport protocol (HTTP) or the like. The user typically authenticates his or her identity to the server 602 to obtain a session identifier (“SessionID”) that identifies the user in subsequent communications with the server 602. When the identified user requests access to a virtual application 628, the runtime application generator 620 suitably creates the application at run time based upon the metadata 638, as appropriate. The query generator 614 suitably obtains the requested data 632 from the database 630 as needed to populate the tables, reports or other features of the particular virtual application 628. As noted above, the virtual application 628 may contain Java, ActiveX, or other content that can be presented using conventional client software running on the user device 640; other embodiments may simply provide dynamic web or other content that can be presented and viewed by the user, as desired.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a tangible non-transitory processor-readable medium in certain embodiments. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for transitioning an electronically displayed public mode of written conversation to an electronically displayed private mode of written conversation, the method comprising:
identifying a displayed public thread that conveys a conversation among a plurality of users;
receiving an instruction to transition at least some content of the displayed public thread to a private setting;
in response to receiving the instruction, initiating a private communication application; and
continuing the conversation among at least some of the plurality of users in a private environment, using the private communication application.

2. The method of claim 1, wherein the private communication application comprises a live chat application, a private message application, an instant message application, a private commenting application, a private feature of a social network application, a private feature of an enterprise collaboration application, or a private discussion forum.

3. The method of claim 1, wherein:
the displayed public thread is associated with an account in a social networking application; and
the account belongs to one of the plurality of users.

4. The method of claim 1, wherein the displayed public thread is associated with a public online discussion forum.

5. The method of claim 1, wherein the displayed public thread is associated with a public online commenting feature.

6. The method of claim 1, further comprising providing a graphical user interface (GUI) control element for the displayed public thread, wherein the instruction is associated with user activation of the GUI control element.

7. The method of claim 1, further comprising copying at least a portion of the displayed public thread for use with the private communication application, resulting in copied content.

8. The method of claim 7, further comprising editing the copied content before continuing the conversation.

9. The method of claim 1, further comprising:
generating a list of potential participants for continuing the conversation with the private communication application, wherein the list of potential participants includes at least some of the plurality of users; and
modifying the list of potential participants before continuing the conversation.

10. The method of claim 1, further comprising:
identifying potential participants for continuing the conversation with the private communication application; and
sending invitations to join the private conversation to the identified potential participants.

11. A computer-implemented method for converting a public conversation into a private conversation, the method comprising:
displaying a conversation thread in a first mode that allows the conversation thread to be viewed by a first group of users, wherein the conversation thread conveys a conversation among a plurality of users;
providing a graphical user interface (GUI) control element for the conversation thread;
detecting activation of the GUI control element;
initiating a private communication application in response to detecting the activation of the GUI control element; and
displaying at least some of the conversation thread in a conversation field generated by the private communication application, resulting in a private conversation thread; and
assigning access rights to the private conversation thread to a second group of users, while inhibiting access to the private conversation thread by other users.

12. The method of claim 11, wherein the second group of users only includes users selected from the plurality of users.

13. The method of claim 11, wherein the second group of users includes at least some of the plurality of users.

14. The method of claim 11, wherein the private communication application comprises a live chat application, a private message application, an instant message application, a private commenting application, a secure feature of a social network application, a secure feature of an enterprise collaboration application, or a private discussion forum.

15. The method of claim 11, further comprising:
identifying members of the second group of users; and
inviting the members to join the private conversation.

16. The method of claim 11, further comprising:
creating a database object corresponding to the second group of users such that the database object exists for a defined time duration; and
automatically deleting the database object upon completion of the defined time duration.

17. A computer-implemented system comprising a processor and a memory, wherein the memory comprises computer-executable instructions that, when executed by the processor, cause the computer-implemented system to:
provide and maintain a first conversation thread using a non-private communication application, wherein the first conversation thread conveys conversation content among a plurality of users;
detect a user-entered instruction to move at least some of the conversation content to a private setting;
initiate a private communication application in response to detection of the user-entered instruction; and
provide and maintain a second conversation thread using the private communication application, wherein the second conversation thread contains at least some of the conversation content from the first conversation thread.

18. The system of claim 17, wherein:
the computer-implemented system comprises a server system;
the server system maintains and provides the non-private communication application as a first online network-based application; and
the server system maintains and provides the private communication application as a second online network-based application.

19. The system of claim 17, wherein:
the computer-executable instructions, when executed by the processor, cause the computer-implemented system to provide a graphical user interface (GUI) control element for the first conversation thread; and
the user-entered instruction is associated with activation of the GUI control element.

20. The system of claim 17, wherein the computer-executable instructions, when executed by the processor, cause the computer-implemented system to:
identify potential participants for the second conversation thread; and
send invitations to join the second conversation thread to the identified potential participants.

21. A computer-implemented method for managing groups of users, the method comprising:
creating a group of users of a social network application, the group of users having a limited and defined lifespan;
supporting group functionality with the social network application during the lifespan of the group of users; and
automatically deleting the group of users upon completion of the lifespan.

22. The method of claim 21, wherein the lifespan is a temporal lifespan for the group of users.

23. The method of claim 21, further comprising:
receiving, from one of the users of the social network application, group configuration data that indicates the lifespan.

24. The method of claim 21, wherein the social network application is hosted by a multi-tenant database system.

25. The method of claim 21, wherein:
the creating comprises creating a database object corresponding to the group of users such that the database object exists only during the lifespan; and
the deleting comprises automatically deleting the database object upon completion of the lifespan.
